(19) United States
(12) Patent Application Publication
(10) Pub. No.: US 2007/0019217 A1
(43) Pub. Date: Jan. 25, 2007

(54) Color calibration method and structure for vector error diffusion

(75) Inventor: Ching-Wei Chang, Vancouver, WA (US)

Correspondence Address: ROBERT D. VARITZ, P.C., 4915 S.E. 33RD PLACE, PORTLAND, OR, 97202, US

(73) Assignee: Sharp Laboratories of America, Inc.

(21) Appl. No.: 11/188,609

(22) Filed: Jul. 24, 2005

(51) Int. Cl. H04N 1/60

(52) U.S. Cl. 358/1.9; 358/518

(57) ABSTRACT

A color calibration method (and related structure) usable in a color-image vector error diffusion system which includes an image input device operating in one color space, and an n-bit, multi-level image output device operating in an output-device-specific version of another color space. The method includes the steps of performing a first image-data conversion which maps image data from the mentioned one color space to a generic version of the mentioned other color space, and thereafter performing a calibrated, second image-data conversion which maps image data from a generic version of the mentioned other color space to the mentioned output-device-specific version of the other color space.

### BACKGROUND AND SUMMARY OF THE INVENTION

This invention relates to a special method and apparatus for performing and utilizing output-device-specific color calibration between a color-imaging output device such as a printer, and a color-image input device which operates in a different color space with respect to that employed by the output device. In particular, it involves such technology in a vector error diffusion setting which employs, effectively, two different color pallets, one of which has been specifically calibrated to relate the nominal or generic output color space of the output device to the actual, device-specific output color activity in relation to this color space.

The invention specifically operates in a functional setting which utilizes the multi-level output capability of a multi-level image output device, such as a printer, with image data effectively sent to this output device through the functional performance of a special calibrated color palette which maps output device-specific color behavior to what can be thought of as being the nominal color space associated with that device.

For the purpose of illustration herein, a preferred embodiment and manner of practicing the invention are described in a setting wherein the input color space is sRGB color space, the nominal, or generic, output color space of the output device (a printer) is CMYK color space, and the output-device-specific color space is what will be referred to herein as a device-specific version of CMYK color space. It should be understood, however, that while the invention is thus illustrated with respect to these, three, just-mentioned color spaces, input color space might typically be one of (a) sRGB color space, (b) cRGB color space, and (c) RGB color space. Similarly, it should be understood that the generic color space for the output device might typically be any one of (a) CMYK color space, (b) CMY color space, and (c) RGB color space. Finally, it should further be understood that the output-device-specific color space might be any one of (a) a device-specific CMYK color space, (b) a device-specific CMY color space, and (c) a device-specific RGB color space. Other color-space conditions may also be accommodated if desired, and the description of the invention which now follows below will fully inform those possessing skill in the art how all such color spaces may be dealt with through practice and operation of the invention.

Especially leading to high-quality color-image output performance utilizing a multi-level output device, as was mentioned earlier herein, is the utilization of a second-level color palette immediately upstream from the output device, which second-level color palette has been calibrated to draw a cross-relationship between the nominal, or generic, color space of the output device and the actual, output-device-specific behavior in that same general color space.

The various features and advantages offered by the invention will now become more fully apparent as the description which follows below is read in conjunction with the accompanying drawings.

### DESCRIPTION OF THE DRAWINGS

FIG. 1 is a high-level, block/schematic diagram generally illustrating the structure and practice of the present invention.

FIG. 2 is a somewhat more detailed block/schematic diagram which implements the arrangement set forth in FIG. 1 in a setting wherein (a) a digital color-image input exists in sRGB color space as a first, or input, color space (color space 1), (b) a multi-level output device is associated with a generic CMYK color space, and (c) the output device per se actually performs in what is referred to herein as a device-specific output color space which is a device-specific version of CMYK color space. The mentioned generic CMYK color space is also referred to herein as a second color space (color space 2), and the device-specific color space associated with the output device is referred to herein also as a third color space (color space 3).

FIG. 3 is a block/schematic diagram illustrating a practice of the present invention which is referred to as a first color conversion practice.

FIG. 4 is a block/schematic diagram generally illustrating practice of the invention to create what is referred to herein as Color Palette A, which palette plays a role in the first color conversion illustrated in FIG. 3.

FIG. 5 illustrates in block/schematic form the use of a second-level color palette referred to a Color Palette B, and further illustrates steps performed in accordance with practice of the invention to create Color Palette B as an output device-specific calibrated color palette.

FIG. 6 is a stylized, block/schematic story-telling drawing generally describing first, second and third color spaces which may be accommodated in the system and methodology of the invention.

FIG. 7 is yet another high-level, block/schematic diagram which illustrates the organization and practice of the present invention in a manner which points out that, in the practice of the invention, vector error diffusion (VED) takes place in a functional region which lies between what are referred to herein as Color Palettes A and B.

### DETAILED DESCRIPTION OF THE INVENTION

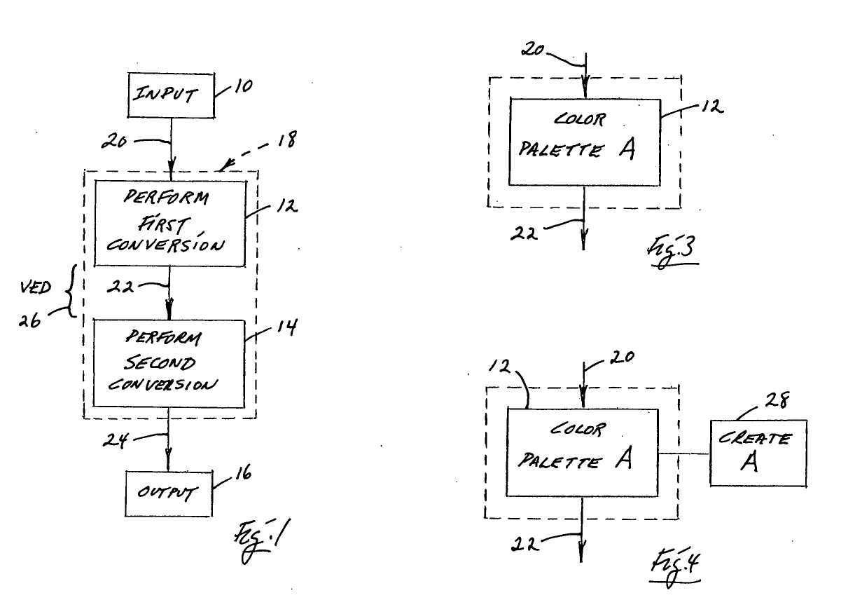

Turning now to the drawings, and referring first of all to FIG. 1, four solid-outline blocks 10, 12, 14, 16, and a dashed-outline block 18, generally picture the structure and methodology of the present invention in a full operational setting between a color-image input device, block 10, which operates in sRGB color space, and a multi-level color printer, or output device, block 16, which operates nominally in a device-specific version of CMYK color space.

Arrows, 20, 22, 24 generally illustrate the flow of color-image data handling as illustrated in FIG. 1, with color-image data which flows in the region of arrow 20 existing in sRGB color space, color-image data flowing in the region illustrated by arrow 22 operating in generic CMYK color space, and color-image data flowing in the region indicated by a arrow 24 operating in a modified CMYK color space which is device-specific to output device 16.

A small bracket shown at 26 on the left side of FIG. 1 represents, generally, the region in the practice illustrated in FIG. 1 wherein vector error diffusion (VED) takes place between first and second performed color conversions which are represented by blocks 12, 14, respectively, in FIG. 1.

Dashed, outline block 18 effectively represents the region of what is shown in FIG. 1 which represents the core methodology and structural architecture of the present invention.

Looking at FIG. 1 specifically with respect to its high-level representation of, for example, the methodology of the present invention, what is generally illustrated in FIG. 1 is a color calibration method which is useable in color-image vector error diffusion in relation to an image input device (10) operating in one, input color space (SRGB color space) and a multi-level image output device (16) operating in an output device-specific version of a generic CMYK color space. The steps of this method include performing a first image-data conversion (block 12) which maps image data from the input sRGB color space to a generic-version of the output device's nominal color space (CMYK color space), and thereafter performing a calibrated, second image-data conversion (block 14) which maps image data from the mentioned generic version of CMYK color space to the device-specific CMYK color space of output device 16. Vector error diffusion 26 takes place functionally in the region which lies between first and second color-space conversions represented by blocks 12, 14, respectively.

Thus, color conversion from illustrative sRGB input color space to illustrative CMYK “output-device-calibrated” output color space, in accordance with practice of the present invention, takes place in two stages—passing, so to speak, through an intermediate stage called “generic” CMYK color space—a color space generically related to the defined, nominal color space of a particular output device. This “generic” CMYK color space, as those skilled in the art will understand, may be characterized, or defined, by any one of a number of different families of particular CMYK “settings”, the specific values of which are not critical to practice of this invention. In other words, any appropriate “values” for these settings, which would be recognized by those skilled in the art as lying normally within the ranges of the usual CMYK settings values for various output devices which are nominally CMYK output devices, may be employed in the practice of this invention to “define” the intermediate, “generic” CMYK color space referred to herein.

The first color-image data conversion (mentioned above) which is performed in the practice of the invention converts color-image input data to data residing in the chosen “generic” color space, whatever its selected “settings” are, and the second-mentioned color-image data conversion then converts data from the chosen “generic” color space condition to a calibrated condition of the actual operating color space of the selected output device. Thus, one can see that the specific defining settings selected for a “generic”, intermediate color space are not ultimately critical to implementation of the invention. This will become very apparent as the detailed description of the invention now continues.

Turning attention now to FIG. 2 in the drawings, here the contents of FIG. 1 are shown with a greater degree of specificity. In this figure, it will be noted that blocks 12, 14 of FIG. 1 are also illustrated, and are very specifically designated as representing two different color palettes referred to herein as Color Palette A and Color Palette B. One will also note that a block 12A is presented in FIG. 2 to represent the fact that Color Palette A actually functions in two performance locations in the practice of the present invention, and it should be understood, therefore, that, blocks 12, 12A each represents effectively the same Color Palette A. Those generally skilled in the relevant art will immediately understand from the more detailed block/schematic diagram of FIG. 2 just how the organization of the present invention functions to perform the methodology of the invention.

Reference characters 20, 22, 24 in FIG. 2 relate to arrows 20, 22, 24, respectively, in FIG. 1 to indicate regions in FIG. 2 wherein what have been referred to earlier herein as the first, second and third color spaces define color image data “flowing” in that region of the operation of the invention. Thus, in FIG. 2, reference numeral 20 points to a region wherein sRGB input color space data flows, reference numeral 22, a region wherein a generic version of CMYK color space data exists, and reference numeral 24, a region wherein device-specific CMYK color space flows. With respect to the generic and device-specific versions of CMYK color space. it should be understood that the different colors specifically employed in these regions are appropriate to what ever the specific character of N-bit multi-level color space operation specifically characterizes the operation of printer output device 16. For the purpose of illustration herein n will be assumed to be 2. As a consequence, printer 16 is capable of printing forty (40) different colors.

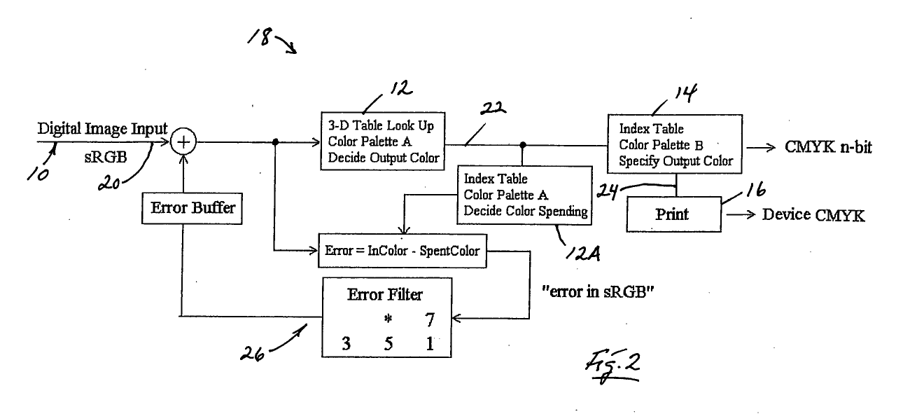

Taking a look now at FIGS. 3-7, inclusive, before specifically describing the natures of, and manners of creating, Color Palettes A and B, FIG. 3 generally illustrates a first-performed color-imaging data conversion which utilizes Color Palette A to map color-image data from input color space sRGB to a generic version of CMYK color space.

FIG. 4, which is similar to FIG. 3 except that it shows a new block 28, illustrates generally a contemplated practice in accordance with the invention for creating Color Palette A. Construction of Color Palette A will be described shortly.

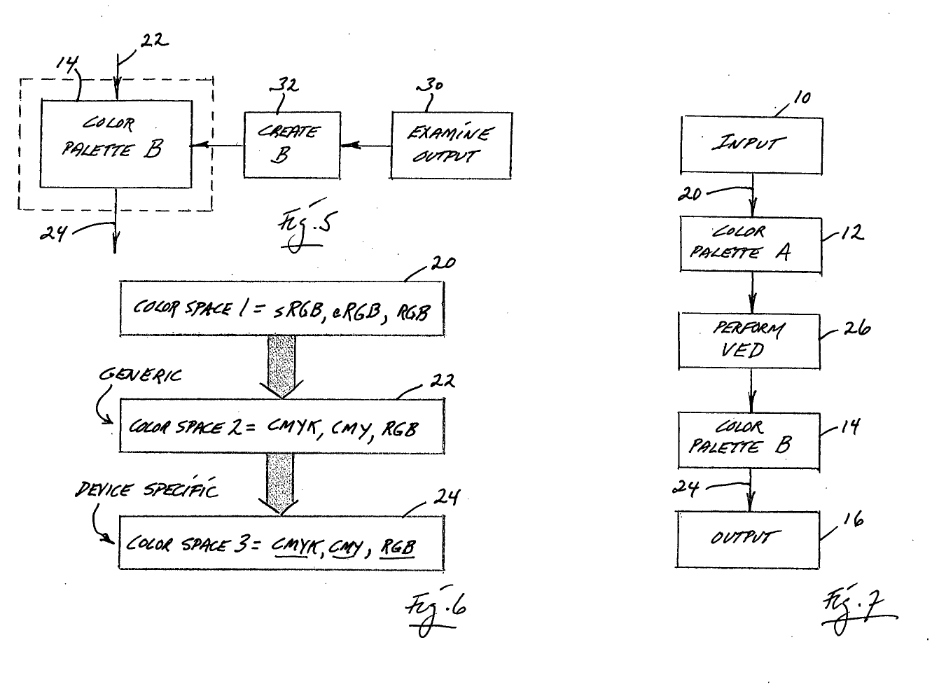

FIG. 5 illustrates a second-performed color-image data conversion, which maps such data from generic CMYK color space to output device-specific CMYK color space utilizing Color Palette B to accomplish this mapping. Color Palette B is generally created in accordance with the practice represented by blocks 30, 32 in FIG. 5, which activity will also be explained shortly.

FIG. 6 generally illustrates, as was mentioned earlier herein, the fact that the first, second and third color spaces which have been referred to herein may typically involve several, different, well-understood color spaces. This accommodation of the present invention is represented in FIG. 6 by blocks numbered 20, 22, 24 in order to relate these blocks directly to the same reference numerals employed variously in FIGS. 1-5, inclusive.

Finally, FIG. 7 provides another view (somewhat like FIG. 1) of the invention which points out clearly that vector error diffusion is performed generally in the operational region that lies between the activities and locations of Color Palettes A and B.

With respect to the creation of color palette A, through the use of any suitable, conventional color-conversion tool and practice, well within the skill and knowledge of those generally skilled in the relevant art, the input sRGB colors associated at the input side of the invention are correlated and associated in Color Palette A with values describing a generic version of CMYK color space. Specifically this correlation is established for all of the forty, nominal CMYK colors which will be employed by the particular multi-level output device selected for output device 16.

With reference to FIG. 2 in the drawings, Color Palette A, illustrated at 12 in this figure, operates effectively to cross-relate input sRGB color space data to generic CMYK color space data. Color Palette A, as represented at 12A in FIG. 2, functions in relation to vector error diffusion to correlate generic CMYK color space image data to sRGB color space image data, with respect to which otherwise conventional and well understood vector error diffusion, illustrated generally at 26 in FIG. 2, takes place.

Block 28 in FIG. 4 represents the palette-creating activity just described of utilizing conventional color conversion practice to create Color Palette A.

Color Palette B is created by causing output device 16 to print each one of its forty nominal output colors “called for”, so-to-speak, (a) by inputting color-image data in generic CMYK color space, (b) by printing the specific output results, (c) by examining (block 30 in FIG. 5) these output results by conventional color spectrophotometric techniques to determine exactly how device 16 performed, and (d) by then utilizing the values of these actual measured output colors to create a cross-correlation relationship between generic CMYK color space and device-specific CMYK color space. This cross-relationship thus defines the make up of Color Palette B. Such printed output examination and palette creation for Color Palette B are represented, respectively, by blocks 30, 32 in FIG. 5.

Thus, one can see that by creating specially calibrated Color Palette B, and by placing it functionally in an overall n-bit multi-level output arrangement such as that shown in FIG. 2, with vector error diffusion being employed in the region between the illustrated and described first and second color conversions, a very high-quality color relationship is created between input imagery in one color space, and printed output imagery in another color space. Lying near the core of this high-quality behavior is the illustrated use of two different color palettes, one of which is specially calibrated to recognize the specific behavior of a selected printing output device.

I claim:

1. A color calibration method usable in a color-image vector error diffusion system which includes an image input device operating in one color space, and a multi-level image output device operating in an output-device-specific version of another color space, said method comprising
performing a first image-data conversion which maps image data from the mentioned one color space to a generic version of the mentioned other color space, and thereafter
performing a calibrated, second image-data conversion which maps image data from a generic version of the mentioned other color space to the mentioned output-device-specific version of the other color space.

2. The method of claim 1, wherein said first-mentioned performing utilizes a color palette which has been created using a generic profile that relates the mentioned one color space to the generic version of the mentioned other color space.

3. The method of claim 2 which further comprises creating the mentioned color palette employing a reverse conversion procedure which is operatively associated with both the mentioned one color space and the generic version of the mentioned other color space.

4. The method of claim 1, wherein said second-mentioned performing is based upon a precursor procedure involving creating a color palette which is output-device color-calibrated.

5. The method of claim 4, wherein said creating involves examining the actual color outputting produced by the output device.

6. The method of claim 1, wherein the mentioned one color space is drawn from the group including sRGB color space, cRGB color space, and RGB color space.

7. The method of claim 1, wherein the generic version of the mentioned other color space is a generic version of a color space drawn from the group including CMYK color space, CMY color space, and RGB color space.

8. The method of claim 1, wherein the output-device-specific version of the mentioned other color space is a device-specific version of a color space drawn from the group including CMYK color space, CMY color space, and RGB color space.

9. The method of claim 1, wherein the mentioned one color space is sRGB color space, the generic version of the mentioned other color space is a generic version of CMYK color space, and the output-device-specific version of the mentioned other color space is an output-device-specific version of CMYK color space.

10. A method involving vector error diffusion in an color-imaging system employing an image input device and a multi-level image output device, which devices operate in different, respective, associated color spaces, said method comprising
preparing and utilizing at least one output-device-specific color palette which is output-device color-calibrated to perform color-image data conversion that maps color-image data which is en route from the input device to the output device to an output color space which is specifically associated with the output device.

11. The method of claim 10, wherein said preparing and utilizing of the at least one color palette results in mapping of color-image data from a generic version of a specific, nominal color space to a non-generic version of that same color space.

12. The method of claim 11, wherein the nominal color space is CMYK color space.

13. A color calibration method useable in a color-image vector error diffusion system which includes a color-image input device operating on one color space, and a multi-level color-image output device operating in a device-specific-version of another color space, said method comprising
performing a first color-image data conversion to map input-image data from the mentioned one color space to a form of intermediate image data in a generic version of the mentioned other color space, and thereafter
performing a calibrated, second color-image data conversion to map such intermediate image data from the generic version of the other color space to a form of output image data in the mentioned device-specific version of the other color space.

14. The method of claim 13, wherein said first and second performing steps are implemented on the upstream and downstream sides, respectively, of where vector error diffusion takes place.

15. A color calibration method for vector error diffusion effective between a color image input device operating in one color space and a multi-level color image output device operating in another color space, said method comprising
preparing a first color palette for use in a practice of vector error diffusion intermediate such color image input and output devices,
basing that preparing upon a reverse color conversion procedure which is effectively applied to a generated and calibrated color profile associated with the operation of the color image input device, and
creating, intermediate the first color palette in the color image output device, a second color palette in the form of a color-calibrated output color index table.

16. A color calibration organization useable in a color image vector error diffusion system intermediate an upstream color image input device which operates in one, input device color space, and a downstream, multi-level, color image output device which operates in another, output-device color space, said organization comprising
first and second, differently configured color palettes disposed in upstream and downstream relative positions respectively between said input and output devices, wherein said first color palette is constructed to map image data from the mentioned one color space to a generic version of the mentioned other color space, and said second color palette is structured to map image data from a generic version of the mentioned other color space to the mentioned output-device-specific version of the other color space.
